(19) United States
(12) Patent Application Publication
(10) Pub. No.: US 2003/0040939 A1
(43) Pub. Date: Feb. 27, 2003

(54) Method of storing and retrieving advance medical directives

(76) Inventors: Daniel Tritch, Fort Wayne, IN (US); Bruce E. Gardner JR., Fort Wayne, IN (US); Cwyn D. Weldy, Elkhart, IN (US); Matthew R. Moran, Fort Wayne, IN (US)

Correspondence Address: BAKER & DANIELS, 111 E. WAYNE STREET, SUITE 800, FORT WAYNE, IN, 46802

(21) Appl. No.: 09/939,380

(22) Filed: Aug. 24, 2001

(51) Int. Cl. G06F 17/60

(52) U.S. Cl. 705/2

(57) ABSTRACT

A method allowing for the rapid retrieval of advance medical directives such as, e.g., living wills and health care proxies. The method of the current invention increases the number of executed advance medical directives, and also increases the likelihood that the correct advance medical directive will be found quickly and efficiently when necessary. The method incorporates the marketing of advance health care directives to entities responsible for providing payment for health care services. By marketing advance health care directives to the entities responsible for providing payment for health care services, the exorbitant costs associated with unnecessary, i.e., unwanted by the patient, medical care are greatly decreased, in part, because a greater number of people who will be aware of, and execute, an advance medical directive will increase. The executed advance medical directives are stored in a central database for later retrieval, e.g., via a telephone or computer query system.

### BACKGROUND OF THE INVENTION

1. Field of the Invention

The invention relates to advance medical directives. More specifically, the field of the invention is that of storing advance medical directives in a central depository for later retrieval by authorized medical personnel.

2. Description of the Related Art

Advance medical directives allow patients to make medical choices regarding their medical care should they become incapacitated or too ill to communicate their wishes. Typically, advance medical directives take the form of either a living will or a health care proxy. A living will is a document in which an individual indicates the kind and extent of health care they do or do not desire under certain circumstances. A health care proxy is a document in which an individual names a decision maker to make decisions about the health care of the individual who executes the health care proxy (i.e., the executor) in the event the executor becomes incapacitated.

While both of these documents provide flexibility to people wanting to have a voice in their health care when they become incapacitated, many times these documents are not found after the executor becomes incapacitated. Currently, an inordinate number of executed advance medical directives are not available when an individual becomes incapacitated and thus, are not utilized. The present invention seeks to aid both the executor and his/her family members by increasing the likelihood that an executed advance medical directive will be found quickly and efficiently in the event that it is needed. By increasing the likelihood that an executed advance medical directive will be found, the executor will not be forced to undergo unwanted medical procedures, and the executor's family members can be confident that the medical decisions made are consistent with the wishes of the executor. Additionally, the parties responsible for the payment for medical services, e.g., medical insurance providers, will not be required to pay for services that are unwanted by the patient/executor. By relieving insurance companies of responsibility for payment of medical services not wanted by a patient/executor, other policy holders may save money in the form of lower premiums.

Conventionally, advance medical directives are stored in, e.g., a doctor's or an attorney's office. Conventional methods of storing and retrieving advance medical directives further include the use of a central depository for advance medical directives, which central depository may be accessed by authorized care givers. Conventional methods of utilizing a central depository for storing executed advance medical directives utilize advance medical directive forms which are executed in handwriting by the executor, thereby making scanning errors likely. If the handwritten information is scanned into the system improperly, the advance medical directive form may be irretrievable when needed. Conventional methods of distributing and storing advanced medical directives do not disclose a method of effectively marketing the use of advance medical directives, nor do they present an accessible and reliable mechanism for retrieving executed advance medical directives. Because these conventional methods do not function to raise awareness in people about the existence of advance medical directive forms, encourage people to actually execute the forms, and/or present an accessible and reliable mechanism for retrieving executed advance medical directives, they do not cause a significant overall decrease in costs associated with unnecessary (i.e., unwanted by the patient) medical care.

What is needed in the art is a system for decreasing costs associated with unnecessary (i.e., unwanted by the patient) medical care. Further needed is a system for increasing the probability of accurately finding executed advance medical directives quickly and efficiently in the event that they are needed.

### SUMMARY OF THE INVENTION

The present invention is a method for decreasing costs associated with unwanted medical care by increasing the awareness of advance medical directives and also increasing the probability of accurately retrieving executed advance medical directives in the event that they are needed.

Advance medical directive forms are provided to a party responsible for the payment of medical services. The party responsible for payment of medical services then distributes an integrated packet of forms, including an advance medical directive form, to the applicant. The integrated packet of forms typically consists of an application, medical history forms, and other forms distributed in the normal course of business. The applicant executes all of the required forms, including the advance medical directive form, and then forwards all of the forms either back to the entity responsible for the payment of medical services, or to another predetermined central location. In an alternative embodiment, the advance medical directive form is forwarded to the applicant separate from the other documents referred to above.

In one embodiment of the current invention, the advance medical directive form is provided to the executor, and the party responsible for the payment of medical services controls the storage and retrieval of the executed advance medical directive. Control of the storage and retrieval of the advance medical directive by the third party payor increases the likelihood that the executed advance medical directive will be found when needed, since the third party payor has a significant interest in seeing that the advance medical directive is produced when necessary.

The executed advance medical directive forms may include a set of bubbles which may be filled in such that they correspond with the handwritten information provided by the executor. This procedure allows the advance medical directive to be indexed properly, even in the event that the scanner scans one or more of the handwritten indicia, e.g., letters, or numbers incorrectly. The executed advance medical directive form is then input into a central depository, and the original form is either stored, returned to the executor, or destroyed.

Adherence to the aforementioned method has numerous advantages for all parties involved. Because the party responsible for the payment of medical services distributes the advance medical directive form to the executor, the executor is much more likely to have an awareness that such forms exist, and is able to ask the party responsible for payment any questions they have regarding the execution of the advance medical directive form. Additionally, the executed advance medical directive is more likely to be received by the party responsible for scanning the advance medical directive into the central depository because the executor is able to send it, along with the other forms in the integrated packet, directly to the entity responsible for payment for medical services. The entity responsible for payment for medical services has a great interest in having the material executed and appropriately scanned such that it is readily available when necessary.

Furthermore, the costs associated with unwanted medical care may be decreased as a result of the executor executing and submitting the advance medical directive form. This allows the party responsible for payment for medical services to save money, and in turn to pass this cost savings on to other insureds through lower premiums. Lower premiums present a marketing advantage to the party responsible for payment for medical services, i.e., an insurance company. It follows that as a result of being able to offer lower premiums, an insurance company will likely gain clientele. Perhaps most importantly, by making advance medical directives easier to retrieve when needed, and by making it simple for the executor to execute and submit an advance medical directive to the storage facility, the executor is able to exercise some personal autonomy (through the advance medical directive) even when he is unconscious or otherwise unable to communicate. Lastly, the utilization of advance medical directives allows the executor's family to be more comfortable with the medical decisions that are being made, and allows them some peace of mind that the medical choices being made are consistent with the executor's wishes.

The advance medical directive forms of the present invention are designed such that they comply with the most strict legal requirements of the various states. This is an important characteristic because while a person may be domiciled in one state, e.g., Florida, they may be injured in another state, e.g., California. If a form is used which complies with the most strict state requirements, there will not be an issue as to whether the form used meets the requirements of the state in which it is to take effect. Furthermore, the present invention contemplates that one or more flags could be utilized to alert the party responsible for payment for medical services to a possible need to request that the executor either fill out a new advance medical directive form, or revise the already executed form. As discussed hereinabove, if the executor relocates to another state which has different legal requirements than the state in which he was previously domiciled, it may be necessary for the executor to fill out a form which complies with that state's legal requirements. For example, a flag could be signaled by a change in the executor's address (thus signaling a possible change in jurisdictional requirements), or a change in policy or coverage. The system of the present invention can support any document, therefore, if the executor moves to a jurisdiction which requires a form different from the form of the present invention, the system of the present is capable of storing and retrieving that form. Furthermore, an alternative embodiment of the current invention utilizes a timed update to automatically generate a form letter prompting the executor to update their advance medical directive if desired. This automatic update can occur at various timed intervals, including, e.g., every two years. The reminder letters may be generated automatically, or may be manually generated responsive to a message from the storage system.

Authorized users (i.e., health care professionals such as doctors, nurses, or other designated staff members) can access the system storing the executed advance medical directives via, e.g., a standard telephone, facsimile machine, computer, thin-client device, wireless device, and/or a device operable to access the Internet. The user enters identifying information, such as the executor's social security number, and is able to retrieve, via facsimile or personal computer, the desired executed advance directive form within a matter of minutes, thus enabling the executor's wishes regarding medical care to be known.

By providing advance medical directives to parties responsible for the payment of medical services, the present method advantageously increases the number of advance medical directives which are executed and input into a central database. Moreover, the advance medical directive form of the present invention increases the accuracy of recording identifying indicia from the advance medical directive.

### BRIEF DESCRIPTION OF THE DRAWINGS

The aforementioned and other features and objects of this invention, and the manner of attaining them, will become more apparent and the invention itself will be better understood by reference to the following description of an embodiment of the invention taken in conjunction with the accompanying drawings, wherein:

FIG. 1 is a schematic illustration of the method of storing and retrieving advance medical directives in accordance with the present invention;

FIG. 2 is a schematic illustration of the procedures effected by the document processor;

FIG. 3 is a schematic illustration of data flow in accordance with the present invention; and

FIG. 4 is an exemplary advance medical directive form in accordance with the present invention.

### DESCRIPTION OF THE PRESENT INVENTION

The embodiment disclosed below is not intended to be exhaustive or to limit the invention to the precise form disclosed in the following detailed description. Rather, the embodiment is chosen and described so that others skilled in the art may utilize its teachings.

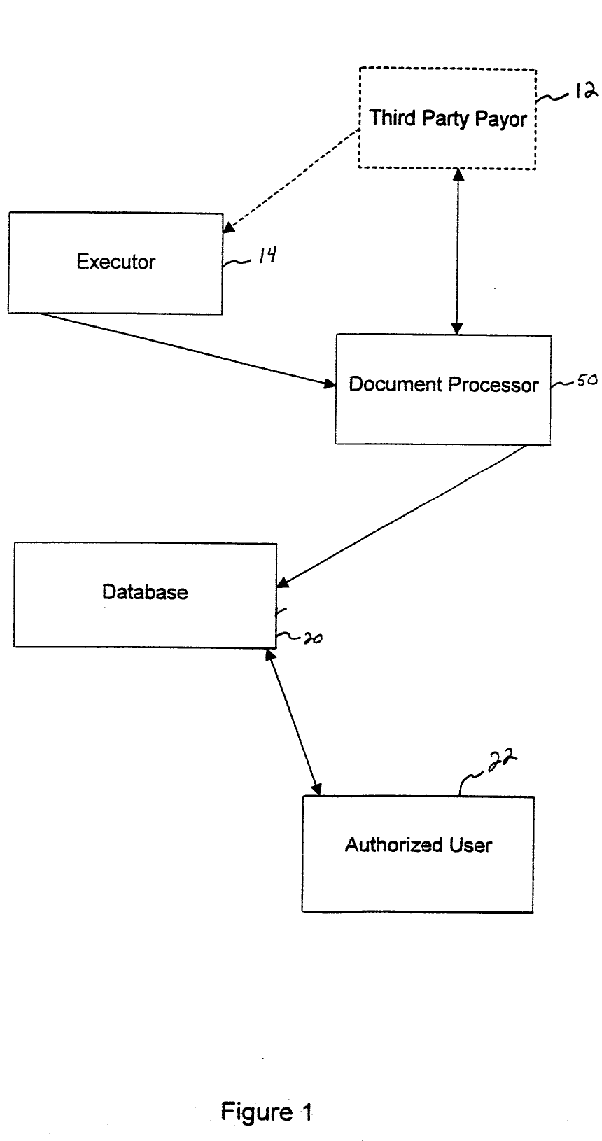

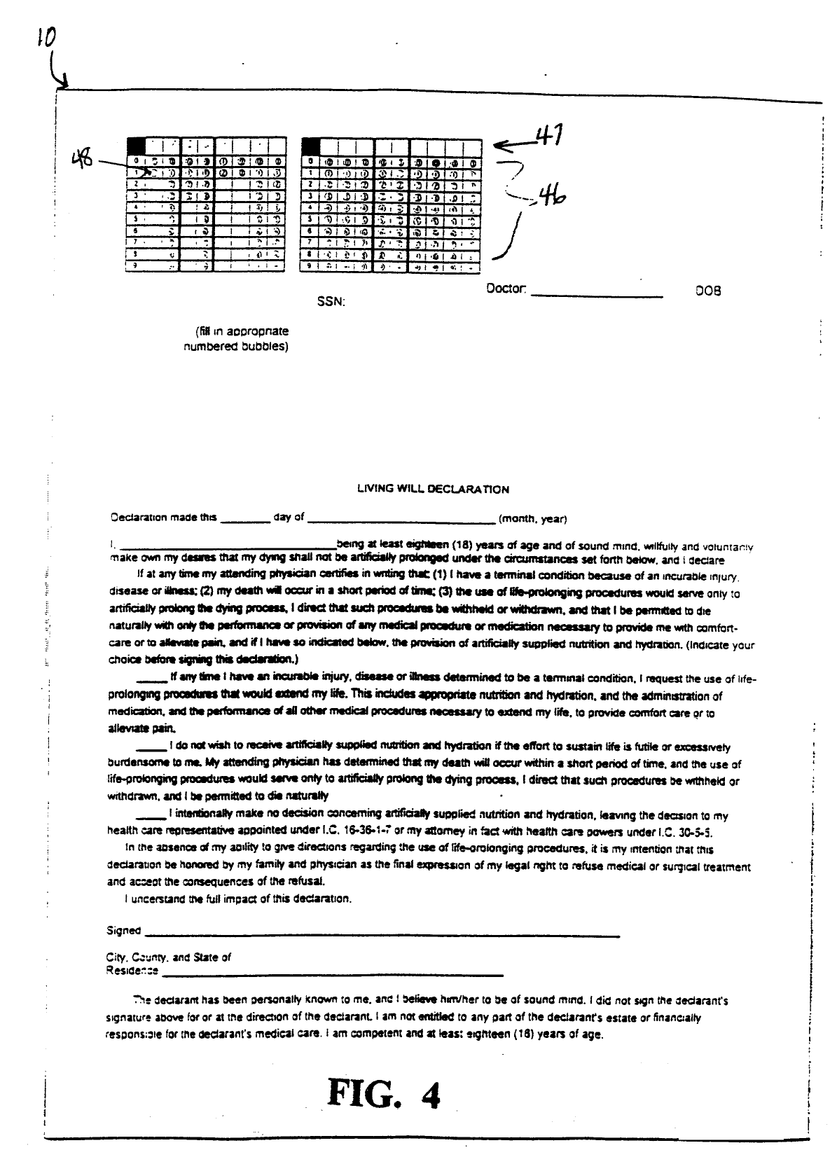

With reference to FIG. 1, advance medical directive forms 10 (FIG. 4) are provided to third party payor 12 responsible for the payment of health care services. In an exemplary embodiment it is contemplated that third party payor 12 will be a medical insurance company. Advance medical directive form 10 is then distributed to executor 14, e.g., an applicant for payment for medical care services. Payor 12 distributes advance medical directive form 10 to executor 14 along with an integrated packet of various forms which are provided to executor 14 as a matter of course. For example, the integrated packet may consist of an application for insurance and questionnaires regarding medical history and current health condition, along with an advance medical directive form 10 to be executed by executor 14. Third party payor 12 requests that executor 14 execute the advance medical directive form 10, along with the other forms included in the integrated packet. If executor 14 chooses to execute the advance medical directive form 10, then the executed form is thereafter forwarded either back to third party payor 12 or to a predetermined central location, e.g., document processor 50. As illustrated in FIG. 1, document processor 50 is communicatively connected to database 20. Database 20 is operable to store executed advance medical directive forms 10 for retrieval by authorized user 22.

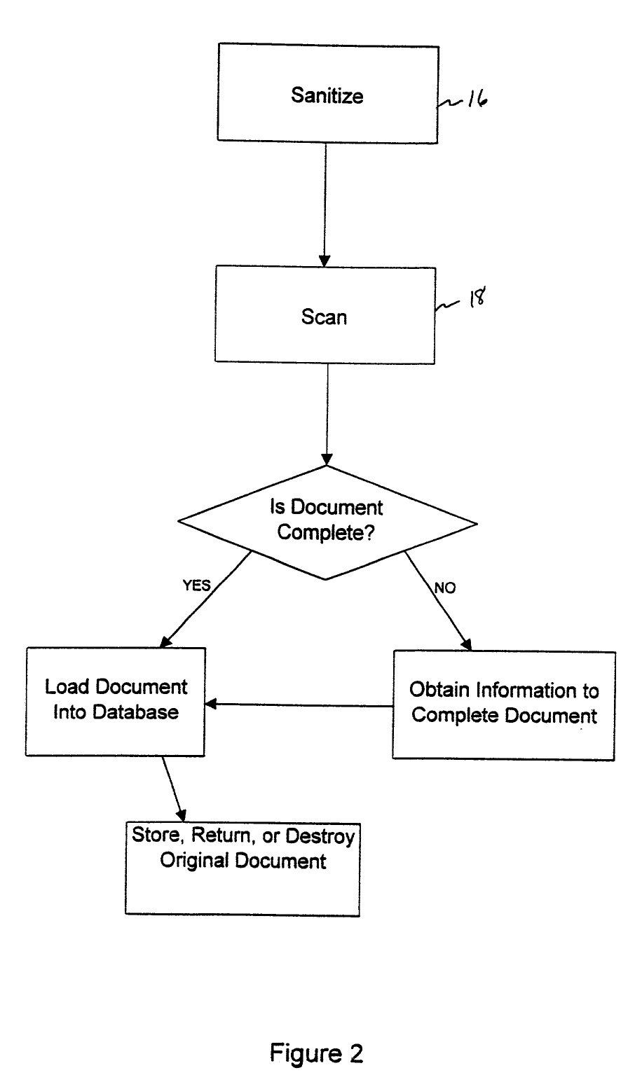

Once executed advance medical directive forms 10 reach document processor 50, they undergo the process schematically illustrated in FIG. 2. As illustrated in FIG. 2, executed advance medical directive forms 10 are “sanitized” (illustrated generally at 16) upon arrival, i.e., staples and paperclips are removed, corners are unbent, and folds are uncreased. Thereafter, executed advance medical directive forms 10 are scanned (illustrated generally at 18), and a determination is made as to whether the scanned document is complete. As illustrated in FIG. 2, if the scanned document is complete, then it is loaded into a computer file in central database 20 via a high speed scanner (not shown), and thereafter indexed via executor social security number or other chosen identifier. In one exemplary embodiment, a Bell & Howell high speed scanner is utilized. The original executed advance medical directive is then stored, returned to the executor, or destroyed as illustrated in FIG. 2. If the scanned document is incomplete, then document processor 50 contacts, e.g., the executor to obtain information to complete the advance medical directive. After the advance medical directive is completed, it is thereafter loaded into the document database as described above.

Multiple storage options exist for the original advance medical directive forms 10 once they have been input into database 20. The executed advance medical directive forms 10 may either be stored in a secured long term storage facility, or they may be returned to the executor.

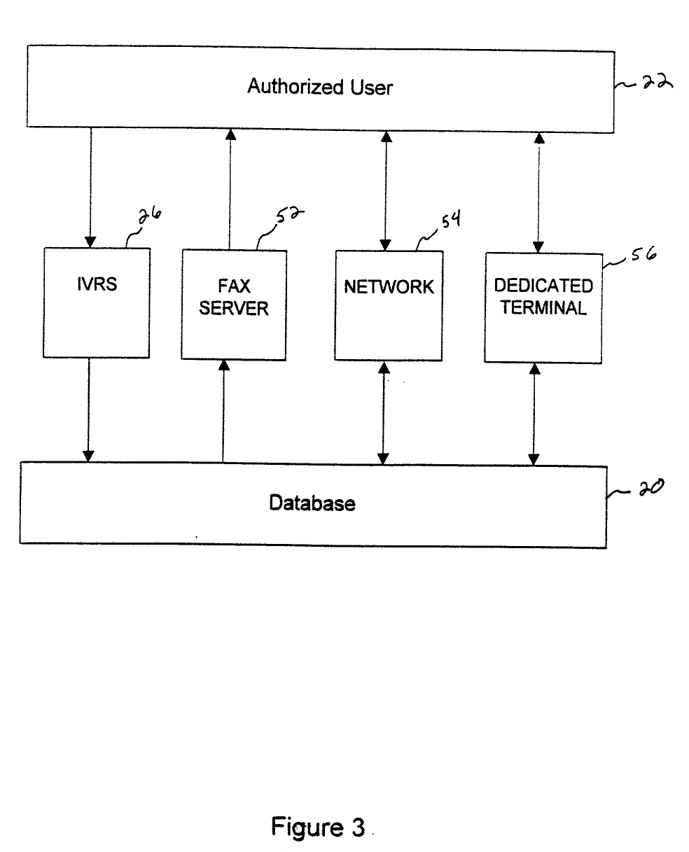

With reference to FIG. 3, to access an executed advance medical directive stored in database 20, authorized user 22 can access database 20 via various methods of communication. For example, authorized user 22 may call into database 20 via a standard telephone (not shown). In this embodiment, Integrated Voice Response System (IVRS) 26 plays a standardized “welcome and login” script responsive to the telephone call from user 22. Integrated Voice Response System 26 then prompts user 22 to enter a PIN/Authorization code, which functions to authenticate user 22 as a valid and privileged user of system 24. Database 20 stores the PIN/Authorization codes of verified users. Once Integrated Voice Response System 26 recognizes user 22 as a valid and privileged user, Integrated Voice Response System 26 then plays an “index” script, which prompts user 22 for a first index, typically the social security number of the executor of the advance medical directive form 10. It is contemplated that other indices could be requested, such as the executor's last name, date of birth, and/or zip code.

Once user 22 enters an index term, such as a social security number, Integrated Voice Response System 26 checks the index term for valid format by comparison with a predetermined format specification. Next, Integrated Voice Response System 26 searches the computer files in database 20 for the document corresponding to the index term entered by user 22. In the event that a matching document is not found, user 22 is notified by a “no document found” script, and the connection between user 22 and Integrated Voice Response System 26 is terminated. If, on the other hand, a matching document is found, user 22 is prompted to specify the desired destination of the data, e.g., a facsimile number, an e-mail address, and/or printing and sending a copy of the document in the mail.

If user 22 is calling directly from a facsimile machine headset, user 22 is prompted to terminate the connection after a matching document is found. If the current facsimile number is registered, a verification script is played and the requested advance medical directive is transmitted to the calling facsimile machine. Furthermore, database 20 stores registered facsimile numbers, and authorized user 22 may select one of the registered facsimile numbers for receipt of the selected advance medical directive. If no facsimile number is registered in database 20, Integrated Voice Response System 26 prompts user 12 to enter a facsimile number. Upon communication of the desired destination, database 20 and fax server 52 cooperate to fax a copy of executed form 10 to the desired destination.

During the call, database 20 records the following information: the date and time of the call, the PIN entered by user 22, and the document requested. This data is recorded for the purpose of assisting in billing user 22 for the use of the system of the present invention. User 22 may be billed for the retrieval of form 10, for transactional type fees associated with contacting the system and/or for delivery charges. This cost may then be shifted to the party responsible for the payment of medical services. In an alternative embodiment, the fees may be billed directly to the appropriate party, i.e., the party responsible for payment of medical services.

Although one exemplary embodiment contemplates a telephone voice inquiry system, other formats are possible. For example, network 54, e.g., a computer network such as the Internet, may be utilized to access database 20. A world wide web interaction using a web page form may be utilized to access database 20. For example, user 22 may contact a web site and enter the same indices described hereinabove. Such an embodiment is advantageous in that it provides greater flexibility and functionality because of the ability to VIEW or PRINT the document from a computer screen. A two-way communication line exists when user 22 connects via a network connection. In a further exemplary embodiment, dedicated terminal 56 can be utilized to access database 20. It is contemplated that a dedicated computer terminal, e.g., a terminal at a hospital could be utilized only for the purpose of retrieving advance medical forms.

The system hardware utilizes one or more of a plurality of servers or a server farm, thus allowing large numbers of users 22 to be connected and to retrieve documents at the same time. The server farm stores database 20 and the applications required to run the system. The server farm is scalable, and additional hard disk drives can easily be added to store more documents. The server farm is either contained and controlled in-house, or it can be outsourced.

An example of software applications which may be utilized to run the system includes the following Feith Systems: FDD Client Software, FDD Scan/View Stations, FDD Server for NT/Windows 2000, Network Fax Enterprise for NT/Windows 2000, and COLD with Vortex Software for NT/Windows 2000. The Feith Systems facilitate imaging and function as a document manager. The system operating system may consist of Microsoft Windows 2000 Server and Microsoft Windows 2000 Advanced Server. Citrix MetaFrame for Windows 2000, Citrix Load Balance, and Citrix Resource Management Services may be used for multiprocessing and Internet transactions. The system may also include Veritas Backup Exec for Windows 2000, which is a disaster recovery package. To protect system 24 from viruses, Network Associates Total Virus Defense (TVD) for Windows 2000 may be utilized.

An example of the hardware which may be utilized to run the system of the present invention includes the following computers from Compaq: Proliant ML370 and associated components; Proliant ML530 and associated components; Proliant ML570 and associated components; Proliant DL380 and associated components; and DL360 and associated components. Cisco PIX Firewall and Cisco Routers & Switches (2600, 2900, and 3600 series) may be utilized to function as Internet connection hardware. Data inquiry may be preserved via Fault Tolerant disk subsystems using RAID drive arrays, tape backup units, redundant hardware components (i.e., power supplies, network interface cards) and remote management functionality.

The system of the present invention provides reliability and increased performance by virtue of the fact that it provides transparent access for users 22, and may be spread across various geographic regions. System 24 is designed to be accessible worldwide from any facility, via either the telephone or Web/Internet access. Additionally, system 24 allows for the addition of new documents, and for the update of existing documents. For example, allergic reactions to medication, medical alerts, or other medical documents may be added to information already stored in database 20.

Referring now to FIG. 4, advance medical directive forms 10 may include area 46 containing a set number of boxes 47 in which the executor writes the digits of his social security number and also fills in bubbles 48 such that they correspond with the information written in boxes 47. This procedure dramatically increases the likelihood of the documents being listed under the correct social security number because the social security number is being entered in more than one manner. The scanner and associated computer software utilized with the present invention is operable to recognize filled-in bubbles in area 46 to accurately record the inventor's social security number. Therefore, if the scanner does not pick up the handwritten number, or scans it incorrectly, the bubble corresponding to the handwritten number will also be filled in. Because the social security number is recorded on the document in more than one manner, the chances of locating the document when it is needed are greatly increased. Additional areas may be included in which other information can be recorded both in writing and by filling in the bubbles, including the executor's name, date of birth, and/or the executor's primary physician. The provision of these indices dramatically increases the chances that the desired advance medical directive will be found if it is stored in the database of the present invention.

It is contemplated that the method of the current invention could be franchised to multiple service providers.

While this invention has been described as having an exemplary design, the present invention may be further modified within the spirit and scope of this disclosure. This application is therefore intended to cover any variation, use, or adaption of the invention using its general principles. Further, this application is intended to cover such departures from the present disclosure as come within known or customary practice in the art to which this invention pertains.

What is claimed is:

1. A method of storing and retrieving advance medical directives, comprising:
a) providing an advance medical directive form to a third party entity responsible for payment of medical services;
b) subsequent to step a), providing said advance medical directive form to an individual for whom said third party entity is responsible for payment of medical services;
c) said individual executing said advance medical directive form; and
d) collecting said advance medical directive for later retrieval.

2. The method of claim 1, wherein said step of providing said advance medical directive to an individual comprises providing an integrated packet of forms including said advance medical directive form.

3. The method of claim 1, further comprising the steps of:
organizing said advance medical directive forms for later retrieval;
providing a central depository for storing a plurality of executed advance medical directives;
scanning said executed advance medical directives into a plurality of computer files;
storing said plurality of computer files in said central depository; and
retrieving said plurality of executed advance medical directives via a query system.

4. The method of claim 3, wherein said central depository comprises a database.

5. The method of claim 3, wherein said query system comprises a telephone response system.

6. The method of claim 3, wherein said query system comprises a computer network interface.

7. The method of claim 3, further comprising the step of recording data to be used for purposes of billing.

8. The method of claim 3, further comprising the step of transmitting the selected advance medical directive to a desired destination.

9. The method of claim 8, wherein said desired destination comprises at least one of a facsimile machine and a computer.

10. A system for storing and retrieving advance medical directives, comprising:
a database for storing a plurality of electronic files containing executed advance medical directive forms, said advance medical directive forms including a plurality of bubbles corresponding to a set of digits and letters, wherein each of said bubbles are filled by an executor according to each of said digits and each of said letters of a specified index;
a scanner for scanning said executed advance medical directive forms;
a computational device operably connected to said scanner and said database, said computational device controlling said scanner and generating said electronic files containing said executed advance medical directive forms for transmission to said server, said computational device operable to read said filled bubbles to determine said specified index, said server indexing said electronic files containing said advance medical directive forms with said specified index;
an interface including a query system for retrieving a selected advance medical directive; and
means for transmitting said selected advance medical directive from said database.

11. The system of claim 10, wherein said specified index comprises an executor's social security number.

12. The system of claim 10, wherein said means for transmitting comprises a facsimile machine.

13. The system of claim 10, wherein said means for transmitting comprises a computer.

14. The system of claim 10, wherein said means for transmitting comprises a fax server.

15. A method of storing and retrieving advance medical directives, comprising:
providing an advance medical directive form to an individual;
said individual executing said advance medical directive form; and
storing said advance medical directive in a central depository controlled by a third party entity responsible for payment of medical services.

16. The method of claim 15, wherein said step of storing said advance medical directive comprises the steps of:
scanning said executed advance medical directives into a plurality of computer files; and
storing said plurality of computer files in said central depository.

17. The method of claim 16, further comprising the step of retrieving said plurality of said executed advance medical directives via a query system.
